(19) United States
(12) Patent Application Publication
(10) Pub. No.: US 2008/0265224 A1
(43) Pub. Date: Oct. 30, 2008

(54) Lifting Mechanism for Players

(75) Inventor: WEISONG CHEN, SHENZHEN CITY (CN)

Correspondence Address: Eric Chan, 42 Pin Oaks Drive, Phoenixville, PA, 19460, US

(73) Assignee: SHENZHEN SKY DRAGON AUDIO & VIDEO TECHNOLOGY CO., LTD., SHENZHEN CITY (CN)

(21) Appl. No.: 11/770,746

(22) Filed: Jun. 29, 2007

(30) Foreign Application Priority Data
Apr. 25, 2007 (CN) 200720119756.3

(51) Int. Cl. B66F 3/44

(52) U.S. Cl. 254/103

(57) ABSTRACT

This Utility Model Invention discloses a lifting mechanism for players, including the main body frame and the player installed on the main body frame. The bottom of the said player is fixed on the connection dock, while the connection dock is connected with a worm coupling support. Inside the main body frame is installed the worm shaft, and the worm coupling frame is coupled with the worm shaft. At the bottom of the said main body frame is installed the gearbox base, and in the gearbox base is installed gear cluster and motor. The bottom end of the worm shaft is connected to the motor via the said gear cluster. This utility model features the maximum protection of the player from being damaged as well as keeping integrity and good appearance of the whole product.

### BACKGROUND OF THE INVENTION

The utility model relates to a lifting mechanism, particularly a lifting mechanism for protection AV player.

With popularization of electronic products of MP3 and MP4 audio-video players, some cloth or leather-made protection cases become available in the market to prevent the MP3 or MP4 players from being damaged during use. These kinds of protection cases can be helpful to prevent the players from being contaminated by dirt and being abraded. However, they can hardly provide adequate protection in case of fierce collision. Additionally, this kind of protection case is troublesome for the users as they have to frequently take the player out of the case when using or closing the player.

### BRIEF SUMMARY OF THE INVENTION

The above-stated problem can be solved effectively by this utility model, which aims to provide a lifting mechanism for protection AV player. The lifting mechanism can provide maximum protection to the player from being damaged as well as keep the overall appearance integrity of the electronic product.

This utility model is achieved mainly through the following technical proposal: a lifting mechanism for player, including main body frame and the player installed on the main body frame; the bottom of the said player is fixed on the connection dock, which features: the connection dock is connected with worm coupling support. Inside the main body frame is installed the worm shaft, and the worm coupling frame is coupled with the worm shaft. At the bottom of the said main body frame is installed the gearbox base, and in the gearbox base is installed gear cluster and motor. The bottom end of the worm shaft is connected to the motor via the said gear cluster.

Between the said connection dock and the worm coupling support is installed the circuit board for controlling the player.

On the said worm coupling support is fixed a guiding axle, and the said worm coupling support is flexibly connected with the guiding axle.

The said guiding axle has a limit switch on its top.

The said gear cluster includes motor driving gear, transient gear and worm driving gear, and the said gears are engaged.

The said worm shaft has a worm fixture on its top and a limit switch on its bottom.

On the said main body frame is installed circuit board for controlling rotation of the motor.

The working principle of the utility model is that the motor driving mechanism installed in the main body frame drives the worm shaft to rotate, and the later drives the worm coupling support to move, which makes the player fixed on the worm coupling support move upward and downward. This utility model can provide the maximum protection of the player from being damaged as well as keeping integrity and good appearance of the whole product.

### BRIEF DESCRIPTION OF THE DRAWINGS

FIG. 1 is the explosion diagram representing the structure of the utility model;

FIG. 2 is the diagram representing appearance of the utility mode;

FIG. 3 is the schematic diagram reprsenting the structure of worm coupling mechanism of the utility model;

FIG. 4 is the A-A Section View; the data timing diagram of the adaptor.

Description of indications in the figures: gearbox base 1, transient gear 2, motor driving gear 3, motor 4, screw 5, gearbox housing 6, worm driving gear 7, worm shaft 8, worm fixture 9, screw 10, worm coupling support 11, connection circuit board 12, player connection dock 13, player 14, guiding axle 15, limit switch 16, screw 17, screw 18, main body frame 19, electronic control circuit board 20, screw 21, screw 22, screw 23, limit switch 24, screw 25.

### DETAILED DESCRIPTION OF THE INVENTION

The utility model will be further explained in detail by using some preferred embodiments in conjunction with the attached drawings.

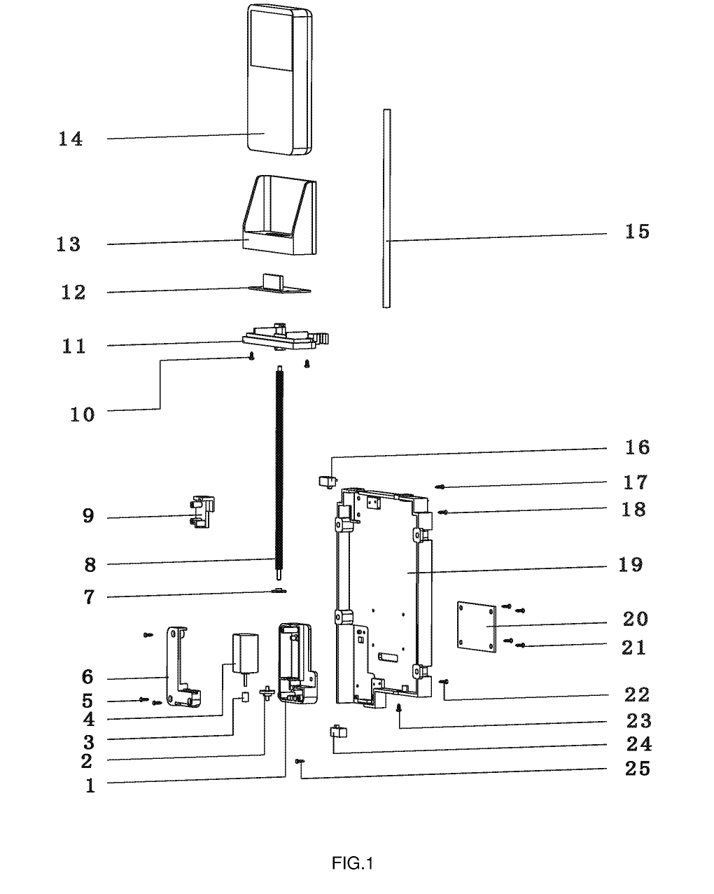

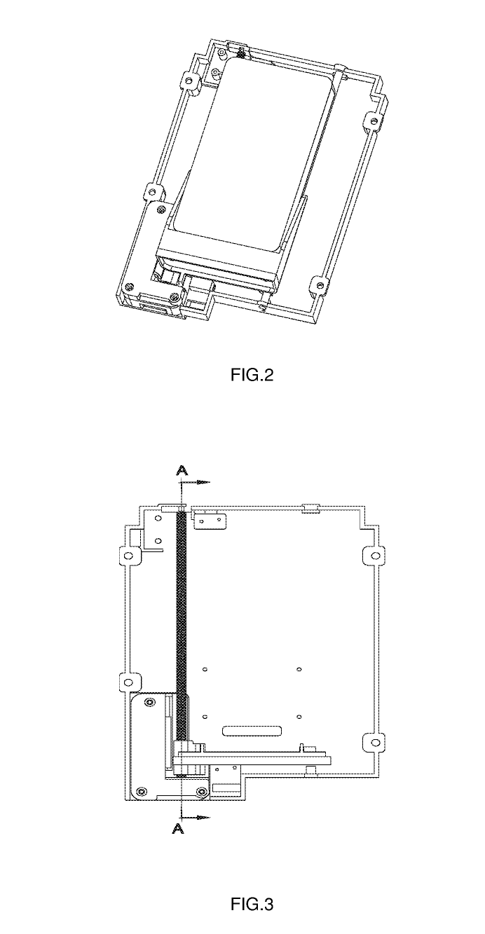

As represented in FIG. 1 and FIG. 2, the player lifting mechanism described in the Claim mainly includes main body frame 19 and player 14 installed on the main body frame 19; the bottom of the said player 14 is fixed on the connection dock 13; on the said connection dock 13 is connected worm coupling support 11; in the said main body frame 19 is installed worm 8, the said worm coupling support 11 and worm 8 are coupled; on the bottom of main body frame 19 is installed gearbox base 1, in the gearbox base 1 is installed gear cluster and motor 4, and the bottom end of worm 8 is connected to the motor 4 via the said gear cluster.

Gearbox base 1 in the utility model and the gearbox housing 6 constitute the gearbox, and these two are secured by screw 5, the said gearbox is installed on the lower end of the main body frame 19 through screw 25; in the gearbox are installed motor 4, motor driving gear 3, transient gear 2 and worm driving gear 7. The said motor 4 is electrically connected to the electronic circuit board 20 through the conducting wire, the axle end of motor 4 is secured to the motor driving gear 3, the motor driving gear 3 is engaged with the transient gear 2, the transient gear 2 is in turn engaged with worm driving gear 7, and the worm driving gear 7 is fixed on the lower end of worm 8. When the motor 4 works, the motor driving gear 3 on the axle end of motor 4 starts to rotate to drive the engaged transient gear 2, so the transient gear 2 drives the worm driving gear 7 to rotate, and eventually the worm driving gear 7 drives the worm 8 to rotate.

The lower end of the worm 8 is fixed in the worm driving gear 7 in the gearbox, and its upper end is fixed on the top end of main body frame 19 through worm fixture 9 and screw 18, while the worm 8 passes through the worm coupling support 11, the two sides of which are respectively fixed on the worm 8 and guiding axle 15. The bottom end of guiding axle 15 is fixed on the lower part of main body frame 19 through strew 23 and limit switch 24, and its top end is fixed on the upper part of main body frame 19 through limit switch 16 and screw 17, where the worm coupling support 11 and guiding axle 15 are flexibly connected, and the main purpose of the guiding axle 15 is to ensure that the worm coupling support 11 can move upward and downward on the vertical plain.

Besides, the lower part of AV player 14 is fixed on the connection dock 13, while the worm coupling support 11 is installed on the bottom of connection dock 13. There is a connection circuit board 12 between worm coupling support 11 and connection dock 13. The said connection dock 13, circuit board 12 and worm coupling support 11 are fixed together through screw 10. The connection circuit board 12 is electrically connected with electronic control circuit board 20 through the conducting wire. The connection circuit board 12 is mainly used to provide power supply for player 14 and to control the operating status of the player 14. The electronic control circuit board 20 is secured on the front side of main body frame 19 through screw 21 and screw 22. On the electronic control circuit board 20 is installed the button used for controlling rotation of motor 4, which realizes the upward and downward movement of the worm coupling support 11.

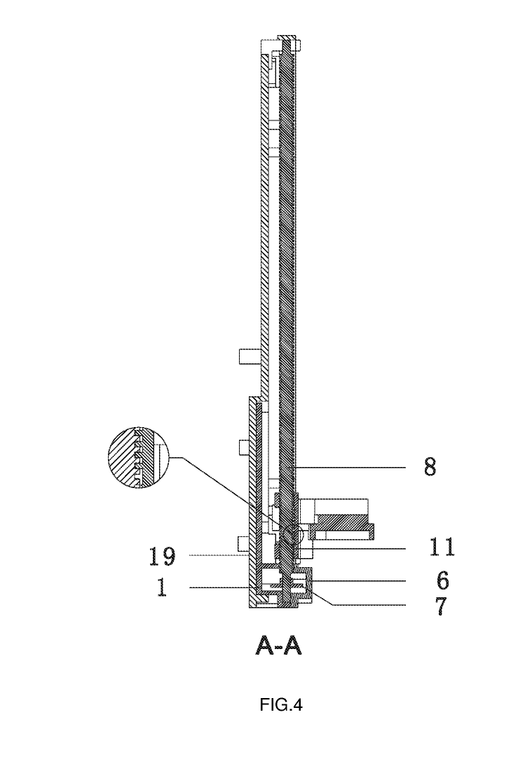

As represented in FIG. 3 and FIG. 4, the worm shaft 8 and worm coupling support 11 described in the Claim constitute the worm coupling mechanism, in which the worm shaft 8 has screw thread winding around, and there are teeth for engaging the said screw thread at the connecting part of the worm coupling support 11 and worm 8. When the worm shaft 8 rotates, the teeth on the worm coupling support 11 and the screw thread on the worm shaft 8 interplay to make the worm coupling support 11 move vertically along the worm shaft 8. During this process, the guiding axle 15 fixed on the other end of the worm coupling support 11 will work together to ensure the worm coupling support 11 to move upward and downward smoothly.

The above is the detailed description of the structure and composition of the utility model, and the following is further description of the working principle of the utility model.

During the working process of the utility model, the button on the electronic control circuit board 20 installed on the front side of the main body frame 19 controls the motor 4 to rotate. If it is necessary to lift up the player 14, the motor 4 is controlled to rotate positively, and the motor 4 rotates to drive the gear cluster to rotate, when the worm shaft 8, driven by the gear cluster, starts to rotate and drive the worm coupling support 11 to lift smoothly through the functioning of gear coupling mechanism, so that the player 14 will lift until completely reveal. The upward movement of the worm coupling support 11 will stop when the it contacts the limit switch 16, and the limit switch 16 on the top of guiding axle 15 will be self-locked, the player 14 will stay at this position when the user can remove the player 14. When it is necessary to move downward the player 14, the control motor 4 rotates reversely; the motor 4 rotates to drive the gear cluster to rotate, and the worm shaft 8, driven by the gear cluster, starts to rotate. The worm coupling support 11, driven by the gear coupling mechanism, will move downward smoothly until the worm coupling support 11 contacts the limit switch 24 at the bottom end of guiding axle 15, when the worm coupling support 11 will stop the downward movement and be self-locked at this position.

The above paragraphs are just some examples of practice of the Invention instead of any limitation in any form to the Invention. The above embodiment is used only for facilitating the understanding of the core concept of the utility model. Any simple modification, amendment, revision, equivalent change or embellishment with the technical essence of the Invention falls into the technical solution and claims of the Invention.

What is claimed is:

1. A lifting mechanism of player, including main body frame (19) and the player (14) installed on the main body frame (19). The bottom of the said payer (14) is fixed on the connection dock (13). This features the following: the said connection dock (13) is connected with the worm coupling support (11), inside the said main body frame (19) is installed a worm shaft (8), and the said worm coupling support (11) is coupled with the worm shaft (8). Installed on the bottom of the said main body frame (19) is the gearbox base (1), and in the gearbox base (1) is installed gear cluster and motor (4). The bottom end of the worm shaft (8) is connected to the motor (4) via the said gear cluster.

2. The invention of claim 1, wherein the player lifting mechanism includes the circuit board (12) for controlling the player installed between the said connection dock (13) and the worm coupling support (11).

3. The invention of claim 1, wherein t the player lifting mechanism also includes a guiding axle (15) fixed on the said worm coupling support (11), which is flexibly connected with the guiding axle (15).

4. The invention of claim 3, wherein the player lifting mechanism also includes a limit switch (16) on the top of the said guiding axle (15).

5. The invention of claim 1, wherein the player lifting mechanism also includes the gear cluster comprising of motor driving gear (3), transient gear (2) and worm driving gear (7), which are engaged.

6. The invention of claim 1, wherein the player lifting mechanism also includes a worm fixture (9) on the top of the said worm shaft (8) and a limit switch on its bottom (24).

7. The invention of claim 1, wherein the player lifting mechanism 1 also includes circuit board (20) on the said main body frame (19), which is used for controlling rotation of the motor (4).
